(19) United States
(12) Patent Application Publication
(10) Pub. No.: US 2016/0177023 A1
(43) Pub. Date: Jun. 23, 2016

(54) CONTINUOUS PROCESS OF OLEFINIC EPOXIDATION BY SUPPORTED HETEROPOLY ACID

(71) Applicant: Chang Chun Plastics Co., Ltd., Taipei (TW)

(72) Inventors: Shih-De Yang, Hukou Township (TW); Ping-Chieh Wang, Hukou Township (TW); An-Pang Tu, Hukou Township (TW); Kuen-Yuan Hwang, Hukou Township (TW)

(73) Assignee: Chang Chun Plastics Co., Ltd., Taipei (TW)

(21) Appl. No.: 14/969,496

(22) Filed: Dec. 15, 2015

(30) Foreign Application Priority Data
Dec. 17, 2014 (TW) 103144161

(51) Int. Cl. C08G 59/02

(52) U.S. Cl. CPC C08G 59/027

(57) ABSTRACT

The subject invention is related to a continuous process of epoxidation of an olefin with supported heteropoly acid catalyst, which does not involve the use of an additive(s). The subject invention separates the products and oxides through a continuous process to reduce backmixing, thereby achieving an efficacy equal to that of a process involving the use of an additive. By excluding additives from the process, the subject invention has a lower cost, and avoids the need for additional wastewater treatment since no alkali metal or alkali earth metal compound is formed during the reaction. Moreover, the continuous process of the invention is also beneficial in industrial manufacturing.

### FIELD OF THE INVENTION

The subject invention is related to a continuous process of epoxidation of olefin with supported heteropoly acid catalyst, which does not involve the use of any additive. The subject invention separates the products and oxides through a continuous process to reduce backmixing and thereby achieve an efficacy equal to that of a process involving the use of an additive. By excluding the additive from the process, the subject invention has lower cost, and avoids additional wastewater treatment since no alkali metal or alkali earth metal compound is formed during the reaction. Moreover, the continuous process of the invention is also beneficial in industrial manufacture.

### BACKGROUND OF THE INVENTION

There are many kinds of methods for epoxidation of olefins. Currently, a chlorohydrin synthesis method, an organic peroxyacid method, an alkyl hydroperoxide method, or the like is commonly used in the industry. However, in addition to defects of these methods involving serious pollution or poor economic efficiency, there are also safety issues regarding the manufacturing processes.

In 1983, Venturello et al. used hydrogen peroxide as an oxide source and the complex of sodium tungstate and phosphoric acid as a catalyst to realize an epoxidation of an olefin. Thereafter, CN 101143919 disclosed a combination of a metal compound catalyst and a phase transferring agent of a quaternary ammonium salt, which achieved superior catalytic reactivity. However, this combination was difficult to recycle and was easily residual in the products. CN 101492528 disclosed immobilizing a quaternary ammonium salt of a heteropoly acid onto a halogenated methylpolystyrene resin to solve the problem associated with recycling of the catalysts. Meanwhile, CN 101891711 disclosed a process for producing an epoxy compound, particularly a cycloaliphatic diepoxide compound, using a phase transferring catalyst. CN 101525320 disclosed a process for synthesizing 3,4-epoxycyclohexylcarboxylate-3′,4′-epoxycyclohexylmethyl using a three-phase transferring catalyst without involving any solvent.

However, the processes disclosed in the above-mentioned CN101492528, CN101891711, and CN101525320 all involve a step of injecting a buffering agent to adjust the pH value so that the hydrolysis of an epoxy resin is reduced. However, use of a buffering agent and an additive would increase the cost of the post-treatment.

To make an epoxy resin have high activity and be easily hydrolyzed, an additive is usually injected. However, the use of an additive would increase the costs and would generate a side product that is difficult to deal with.

### SUMMARY OF THE INVENTION

The inventors have developed a process to overcome the above-identified problems by way of continuous discharging so that the backmixing of the product can be avoided, the selectivity of the products and the production rate increased, thereby benefiting mass production.

The subject invention is directed to a process for continuously manufacturing an epoxy resin, comprising:

placing an immobilized heteropoly acid catalyst into a continuous reactor;

injecting an olefinic solution and a peroxide into the continuous reactor from a feeding end of the continuous reactor to conduct a reaction so that an organic layer and an aqueous layer are formed; and

collecting the epoxy resin from the organic layer,

wherein the reaction steps do not include the use of an additive.

In an embodiment of the subject invention, before collecting an epoxy resin, the process further comprises a step of returning at least a portion of the organic layer to the continuous reactor to conduct a reaction. In another embodiment of the subject invention, the process further comprises transferring at least a portion of the organic layer to another reaction kettle for being ripened.

In an embodiment of the subject invention, the step of collecting the epoxy resin from the organic layer includes removing an organic solvent from the organic layer. In an embodiment of the subject invention, the removing of an organic solvent is by way of a vacuum concentration.

In an embodiment of the subject invention, a continuous process is directed to continuous feeding of a reactant and continuous discharging of a product. A continuous reactor is selected from a continuously stirred tank reactor and a fixed bed reactor.

In an embodiment of the subject invention, a continuous reactor further comprises an apparatus for homogeneously mixing of a reactant and an oxidant with the purpose of increasing the affinity of the water-oil phases and decreasing the effect resulting from the surface tension between the interfaces. The apparatus may be selected from but is not limited to a pipe mixer, a vortex mixer, a static mixer or the like.

In an embodiment of the subject invention, an immobilized heteropoly acid catalyst is selected from phosphotungstic acid, silicotungstic acid, silicomolybdic acid, phosphomolybdic acid or the combination thereof.

In an embodiment of the subject invention, an olefinic solution comprises an alicyclic olefinic compound or an aromatic olefinic compound.

Conventionally, an additive, such as the salt of an alkali metal or alkaline earth metal, must be injected in an olefinic epoxidation process to prompt a catalytic reaction, to stabilize a reaction, or to be used as a pH buffering agent, which may balance a small quantity of acid or base and maintain the overall pH value of the whole system. The process of the subject invention does not involve injecting any additive, so the efficacy of reducing costs and avoiding a processing step regarding any side products are achieved.

### BRIEF DESCRIPTION OF THE DRAWINGS

FIG. 1 is an embodiment of using a fixed bed reactor in accordance with the subject invention.

FIG. 2 is an embodiment of using a continuously stirred tank reactor in accordance with the subject invention.

### DETAILED DESCRIPTION OF THE INVENTION

It should be understood that all numeric ranges referred to in the specification cover every sub-range thereof. For example, the range of 1.5 to 7.5 includes every sub-range between the minimum value 1.5 and the maximum value 7.5 (e.g. the range of 1.8 to 6.3 or 5.8 to 7.3) and said minimum and maximum values, i.e. covering a range between a minimum value equal to or higher than 1.5 and a maximum value equal to or lower than 7.5. Since the disclosed numeric ranges are continuous, they cover every value between the minimum and the maximum values. Unless otherwise specified, all of the numeric ranges referred to in the specification pertain to approximate values.

Heteropoly Acids and Immobilized Heteropoly Acid Catalysts

A heteropoly acid and its polyoxometalate pertain to a multi oxygen metalcomplex comprising a central atom (i.e. hetero-atom, e.g. phosphorus, silicon or the like) and coordinating atoms (i.e. polyatoms, e.g. molybdenum, tungsten or the like) through a molecular space structure built by bridging of oxygen atoms, and pertains to a catalyst with superior properties for an oxidation reaction. Because of the electronegativity of a heteropolyanion, immobilization thereof can be easily realized. The heteropoly acid used in the subject invention can be a complex anion with high molecular weight comprising a multivalent metal atom with an oxygen bond. Typically, each anion comprises a multivalent metal atom with 12 to 18 oxygen bonds. The multivalent metal atoms, i.e. the surrounding atoms, symmetrically encompass one or more central atoms. The surrounding atoms may be one or more of molybdenum, tungsten, vanadium, niobium, tantalum, or any other multivalent metal atom. The central atom is preferably silicon or phosphorus but may further comprise any one of large species of atoms selected from Group Ito VIII of the periodic table, which comprise copper, beryllium, zinc, cobalt, nickel, boron, aluminum, gallium, iron, cerium, arsenic, antimony, bismuth, chromium, rhodium, silicon, germanium, tin, titanium, zirconium, vanadium, sulfur, tellurium, manganese, nickel, platinum, thorium, hafnium, cerium, arsenic, vanadium, antimony ions, tellurium and iodine.

Some known anion structures have been named by researchers in the art and are known as, for example, Keggin, Wells-Dawson, and Anderson-Evans-Perloff heteropoly acids. For example, a specific example of a heteropoly acid catalyst is as follows: 18-phosphotungstic acid (H₆[P₂W₁₈O₈₂]·xH₂O), 12-phosphotungstic acid (H₃[PW₁₂O₄₀]·xH₂O), 12-phosphomolybdic acid (H₃[PMo₁₂O₄₀]·xH₂O), 12-tungstosilicic acid (H₄[SiW₁₂O₄₀]·xH₂O), 12-molybdsilicic acid (H₄[SiMO₁₂O₄₀]·xH₂O), cesium hydrogen tungstosilicic (Cs₃H[SiW₁₂O₄₀]·xH₂), and a free state acid or a portion of a salt of the following heteropoly acids: monopotassium phosphotungstate (KH₅[P₂W₁₈O₆₂]·xH₂O), 12-monosodium tungstosilicate (NaK₃[SiW₁₂O₄₀]·xH₂O), potassium phosphotungstate (K₆[P₂W₁₈O₆₂]·xH₂O), sodium phosphomolybdate (Na₃[PMo₁₂O₄₀]·xH₂O), ammonium diphosphomolybdate ((NH₄)₆[P₂Mo₁₈O₆₂]xH₂O), potassium phosphomolybdhypovanadate (K₅[PMoV₂O₄₀]·xH₂O).

A suitable heteropoly acid catalyst in the subject invention is not limited and may be selected from one or more of the following heteropoly acids: phosphotungstic acid, silicotungstic acid, silicomolybdic acid, phosphomolybdic acid or the combinations thereof. In addition, a mixture of different kinds of heteropoly acids and a salt thereof also may be used. A preferred heteropoly acid catalyst of the subject invention is phosphotungstic acid, and the most preferred one is 12-phosphotungstic acid.

The process involving preparing an immobilized heteropoly acid catalyst of the subject invention is not specifically limited. Many prior arts already disclose a process for preparing an immobilized heteropoly acid catalyst. A person having ordinary skill in the art may prepare an immobilized heteropoly acid catalyst based on the efficacy as needed. For example, CN 101492528 already discloses a process for preparing an immobilized heteropoly acid catalyst. The content of CN 101492528 has been incorporated into the disclosure of the specification as a reference. In an embodiment of the subject invention, an immobilized heteropoly acid catalyst may be prepared as follows: A halogenated methyl polystyrene resin and a compound comprising active tertiary amine groups are dispersed in an organic solvent to conduct a swelling process. An immobilized quaternary ammonium salt resin is formed. A heteropoly acid is processed in an acidic aqueous solution by using an oxidant. Subsequently, the quaternary ammonium salt resin is injected to conduct a reaction. After the reactant is processed, the immobilized heteropoly acid catalyst is thus obtained.

Olefinic Compounds

The subject for epoxidation in the subject invention is an olefinic compound. The process of the subject invention may be applied to any species of an olefinic compound. The olefinic compound comprises at least one double bond and may comprise two or more double bonds. The double bond may be located inside or at a terminal of a molecular structure. The olefinic compound may be a cyclic compound, such as cyclohexene; 4-vinyl-1-cyclohexene; 1-methyl-5-(1-methylvinyl)cyclohexene; dicyclopentadiene; dicyclohexyl-3,3′-diene; 4-(cyclohex-3-en-1-yl-methyl)cyclohexene; 2,2-bis(3′,4′-cyclohexene)propane; 2,2-bis(cyclohexen-3-yl)propane; and a derivative or a mixture of the above-mentioned substances.

The olefinic compound is preferably an alicyclic or aromatic compound, such as 3-cyclohexene-1-carboxylic acid, 3-cyclohexen-1-ylmethyl ester; 3-cyclohexene-1-carboxylic acid, 6-methyl-, (6-methyl-3-cyclohexene-1-yl)methyl ester; 3-cyclohexene-1-carboxylic acid, 3-methyl-, (3-methyl-3-cyclohexen-1-yl)methyl ester; 3-cyclohexene-1-carboxylic acid, 4-methyl-, (4-methyl-3-cyclohexen-1-yl)methyl ester; 3-cyclohexene-1-carboxylic acid, i-methyl-, (1-methyl-3-cyclohexen-1-yl) methyl ester; 3-cyclohexene-1-carboxylic acid, 2-methyl-, (2-methyl-3-cyclohexen-1-yl) methyl ester; 3-cyclohexene-1-carboxylic acid, 3,4-dimethyl-, (3,4-dimethyl-3-cyclohexen-1-yl) methyl ester; 3-cyclohexene-1-carboxylic acid, 1-(3-cyclohexen-1-yl) ethyl ester; 3-cyclohexene-1-carboxylic acid, 1-(3-cyclohexen-1-yl)-1-methyl-ethyl ester; bicyclo[2,2,1]hept-5-ene-2-carboxylic acid, 3-methyl, (3-methyl-bicyclo[2.2.1]hepy-5-en-2-yl) methyl ester; 5-norbornene-2-carboxylic acid, ethylene ester; 1,6-hexanediol bis (norborn-2-ene-5-carboxylate); 3-cyclohexene-1-carboxylic acid, ethylene ester; 3-cyclohexene-1-carboxylic acid, 4-methyl-, 1,2-ethanediyl ester; 3-cyclohexene-1-carboxylic acid, 4-methyl, i-methyl 1,2-ethanediyl ester; 3-cyclohexene-1-carboxylic acid, 6-methyl-, 1,1′-(1,6-hexanediyl ester; 3-cyclohexene-1-carboxylic acid, 1,1′-[1,4-cyclohexanediyl bis (methylene)]ester; carbonic acid, C, C′-[1,4-cyclohexanediyl bis (methylene)]C, C′-bis (3-cyclohexen-1-ylmethyl) ester; ethanedioic acid, 1,2-bis (3-cyclohexen-1-ylmethyl) ester; hexanedioic acid, 1, 6-bis (3-cyclohexen-1-ylmethyl) ester; maleic acid, bis (6-methyl-3-cyclohexen-1-yl methyl) ester; 1,4-cyclohexane dicarboxylic acid, 1,4-bis (3-cyclohexen-1-ylmethyl) ester; 1,1,2,2-ethanetetracarboxylic acid, tetrakis (3-cyclohexen-1-ylmethyl) ester; 1,2,3,4-butanetetracarboxylic acid, tetrakis (3-cyclohexen-1-ylmethyl) ester; bicyclo[2.2.1]hept-5-ene-2-carboxylic acid, 2,2′-[2,2-bis[[(bicyclo[2.2.1]hept-5-en-2-ylcarbonyl) oxy]methyl]-1,3-propanediyl]ester; bicyclo[2.2.1]hept-5-ene-2-carboxylic acid, 2,2′-[2,2-[[bis (bicyclo[2.2.1]hept-5-en-2-ylcarbonyl) oxy]methyl]-2-ethyl-1,3-propane-diyl]ester; di (cyclohex-3-enylmethyl) carbonate; di[1-(3-cyclohexenyl) ethyl]carbonate; dially 1,2-cyclohexanedicarboxylate; diallyl tetrahydrophthalate; 1,2-cyclohexanedicarboxylic acid, 1,2-bis (3-cyclohexen-1-ylmethyl) ester; 4-cyclohexene-1,2-dicarboxylic acid, 1,2-bis (3-cyclohexen-1-ylmethyl) esters; poly[oxy(1-oxo-1,6-hexanediyl)], α-(3-cyclohexen-1-ylmethyl)-ω-[(3-cyclohexen-1-ylcarboxyl) oxy]-; and a derivative or the mixture of the above-mentioned substances.

The olefinic compound also may be a compound comprising an ether bond in its structure, such as bis(cyclopent-2-enyl)ether; bis(cyclopent-3-enyl)ether; 4-(cyclohex-3-en-1-ylmethoxymethyl)cyclohexene; cyclohexene, 3,3′-[methylenebis(oxy)]bis-; 4-(cyclohex-3-en-1-yloxy-methoxy)cyclohexene; ethyleneglycol bis(2-cyclohexenyl) ether; isopropylene glycol bis(2-cyclohexenyl) ether; bis(3-cyclohexen-1-ylmethyloxy) methane; methane, bis (5-norbornen-2-ylmethoxy)-; bicyclo[2,2,1]hept-2-ene, 5,6-bis[(2-propen-1-yloxy]methyl)-; bisphenol A diallyl ether; bisphenol F diallyl ether; cyclohexene, 4,4-bis[(2-cyclohexen-1-yloxy) methyl]-; tetraallyl pentaerythritol ether; and a derivative or the mixture of one or more of the above-mentioned substances.

The olefinic compound also may be a compound comprising a heterocyclic or amino group in its structure, such as 3-cyclohex-2-en-1-yl-2,4-dioxaspiro[5.5]undec-9-ene; spiro[m-dioxane-5,2′-[5]norbornene], 2-(5-norbornene-2-yl)-; bis[4-(diallyl amino) phenyl]methane: aniline, N, N-di-2-propenyl-4-(2-propenyloxy)-; and a derivative or a mixture of one or more of the above-mentioned substances. The olefinic compound may also be a silicate or a phosphate-containing compound in structure, e.g., cyclohexene, 4,4′,4″-[(methylsilylidyne) tris (oxyethyl)]-; silane, tris (bicyclo[2.2.1]hept-5-en-2-ylmethoxy) methyl-; tri (cyclohex-3-enylmethoxy) phenyl silane; silicic acid (H₄SiO₄), tetrakis (3-cyclohexen-1-yl methyl) ester; 3-cyclohexene-1-methanol, 1,1′,1″-phosphate, a derivative or a mixture of the above-mentioned substances; and triallyl isocyanurate.

In an embodiment of the subject invention, the said olefinic compound may be selected from the compounds listed in the following table:

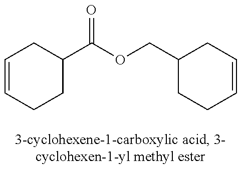 [SMILES: O=C(OCC1CC=CCC1)C1CC=CCC1]

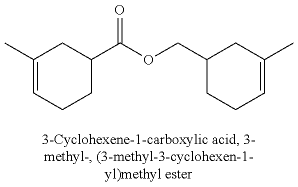

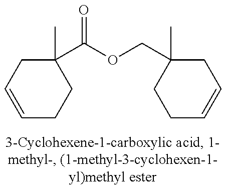 [SMILES: CC1(COC(=O)C2(C)CC=CCC2)CC=CCC1]

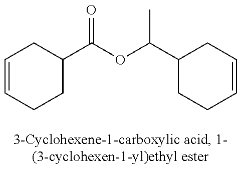 [SMILES: CC(OC(=O)C1CC=CCC1)C1CC=CCC1]

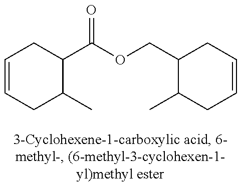 [SMILES: CC1CC=CCC1COC(=O)C1CC=CCC1C]

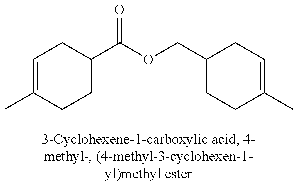

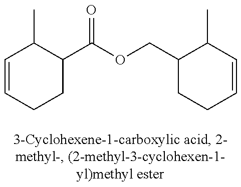 [SMILES: CC1C=CCCC1COC(=O)C1CCC=CC1C]

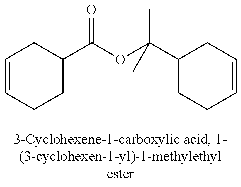 [SMILES: CC(C)(OC(=O)C1CC=CCC1)C1CC=CCC1]

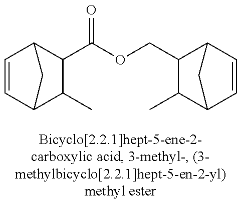 [SMILES: CC1C2C=CC(C2)C1COC(=O)C1C2C=CC(C2)C1C]

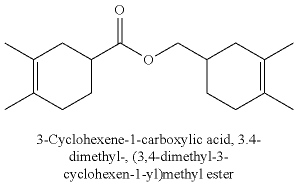

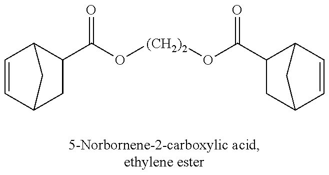

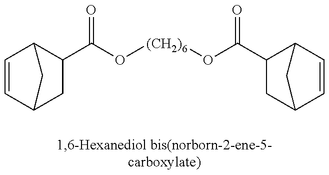

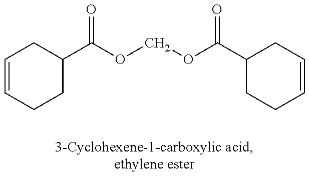 [SMILES: O=C(OCOC(=O)C1CC=CCC1)C1CC=CCC1]

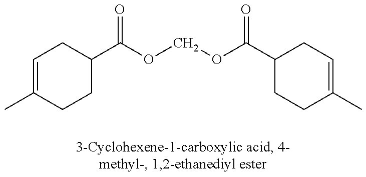

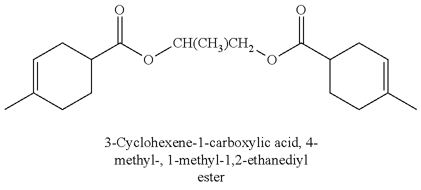

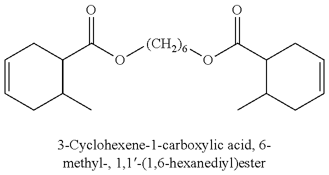

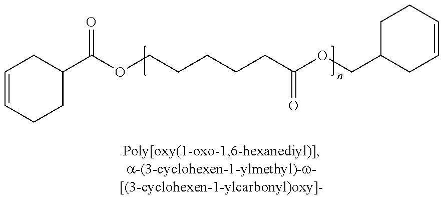

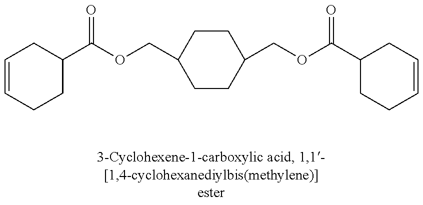 [SMILES: O=C(OCC1CCC(COC(=O)C2CC=CCC2)CC1)C1CC=CCC1]

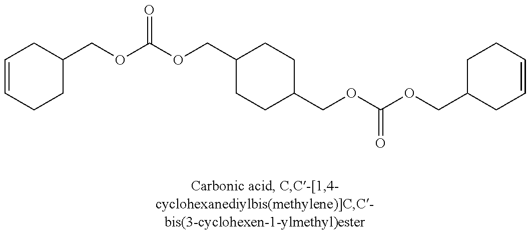 [SMILES: O=C(OCC1CC=CCC1)OCC1CCC(COC(=O)OCC2CC=CCC2)CC1]

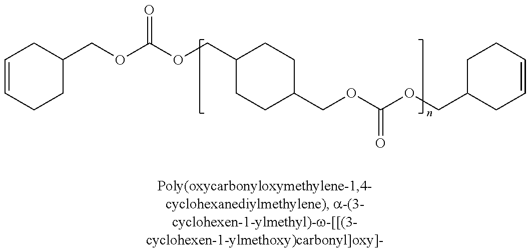

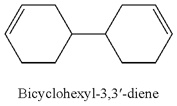 [SMILES: C1=CCC(C2CC=CCC2)CC1]

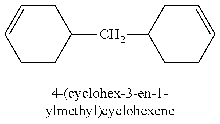 [SMILES: C1=CCC(CC2CC=CCC2)CC1]

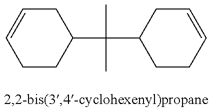

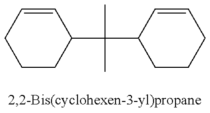

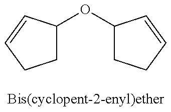 [SMILES: C1=CC(OC2C=CCC2)CC1]

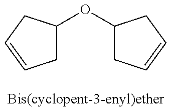 [SMILES: C1=CCC(OC2CC=CC2)C1]

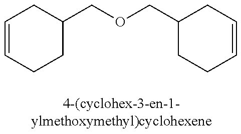 [SMILES: C1=CCC(COCC2CC=CCC2)CC1]

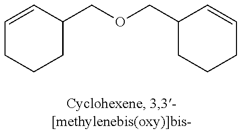 [SMILES: C1=CC(COCC2C=CCCC2)CCC1]

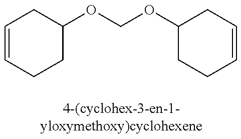 [SMILES: C1=CCC(OCOC2CC=CCC2)CC1]

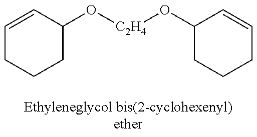

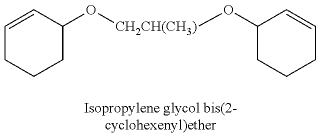

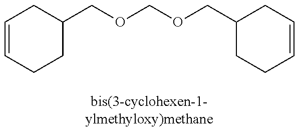 [SMILES: C1=CCC(COCOCC2CC=CCC2)CC1]

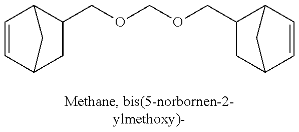 [SMILES: C1=CC2CC1CC2COCOCC1CC2C=CC1C2]

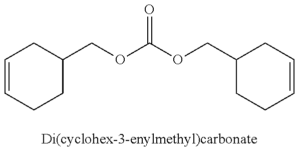 [SMILES: O=C(OCC1CC=CCC1)OCC1CC=CCC1]

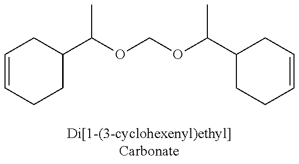 [SMILES: CC(OCOC(C)C1CC=CCC1)C1CC=CCC1]

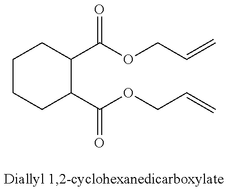 [SMILES: C=CCOC(=O)C1CCCCC1C(=O)OCC=C]

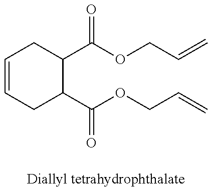 [SMILES: C=CCOC(=O)C1CC=CCC1C(=O)OCC=C]

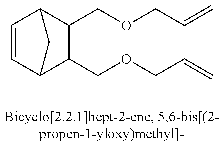 [SMILES: C=CCOCC1C2C=CC(C2)C1COCC=C]

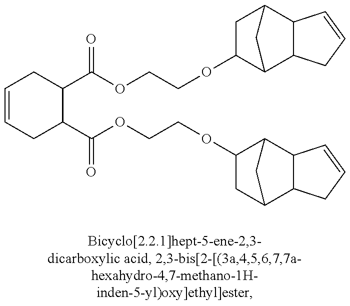 [SMILES: O=C(OCCOC1CC2CC1C1C=CCC21)C1CC=CCC1C(=O)OCCOC1CC2CC1C1CC=CC21]

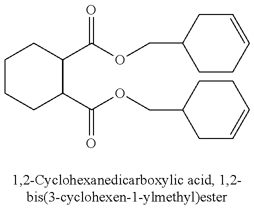 [SMILES: O=C(OCC1CC=CCC1)C1CCCCC1C(=O)OCC1CC=CCC1]

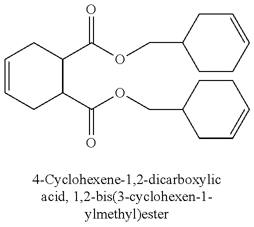 [SMILES: O=C(OCC1CC=CCC1)C1CC=CCC1C(=O)OCC1CC=CCC1]

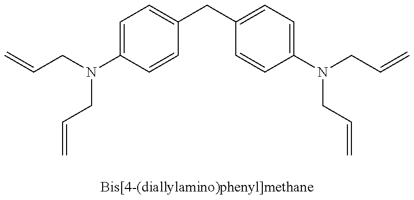 [SMILES: C=CCN(CC=C)c1ccc(Cc2ccc(N(CC=C)CC=C)cc2)cc1]

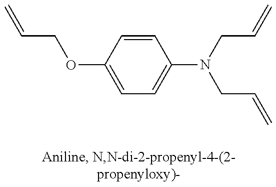 [SMILES: C=CCOc1ccc(N(CC=C)CC=C)cc1]

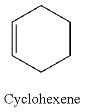

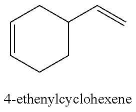

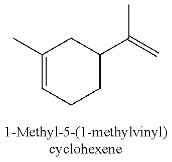

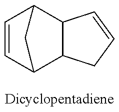

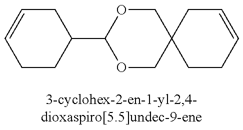 [SMILES: C1=CCC(C2OCC3(CC=CCC3)CO2)CC1]

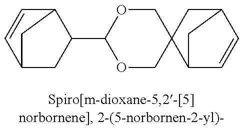 [SMILES: C1=CC2CC1CC2C1OCC2(CO1)CC1C=CC2C1]

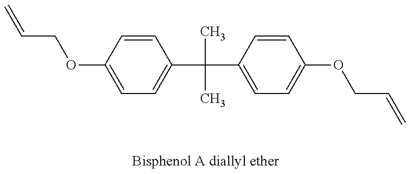 [SMILES: C=CCOc1ccc(C(C)(C)c2ccc(OCC=C)cc2)cc1]

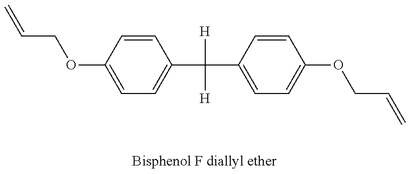 [SMILES: C=CCOc1ccc(Cc2ccc(OCC=C)cc2)cc1]

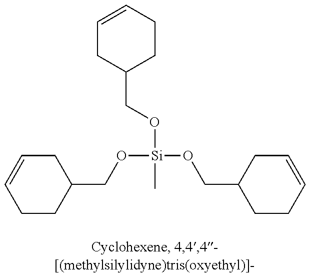 [SMILES: C[Si](OCC1CC=CCC1)(OCC1CC=CCC1)OCC1CC=CCC1]

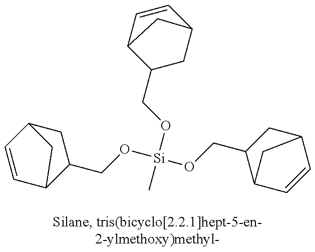 [SMILES: C[Si](OCC1CC2C=CC1C2)(OCC1CC2C=CC1C2)OCC1CC2C=CC1C2]

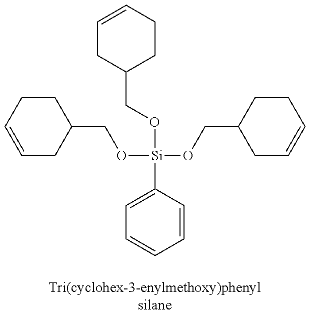 [SMILES: C1=CCC(CO[Si](OCC2CC=CCC2)(OCC2CC=CCC2)c2ccccc2)CC1]

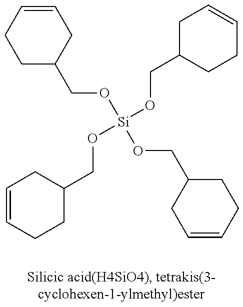 [SMILES: C1=CCC(CO[Si](OCC2CC=CCC2)(OCC2CC=CCC2)OCC2CC=CCC2)CC1]

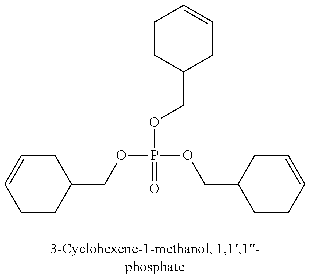 [SMILES: O=P(OCC1CC=CCC1)(OCC1CC=CCC1)OCC1CC=CCC1]

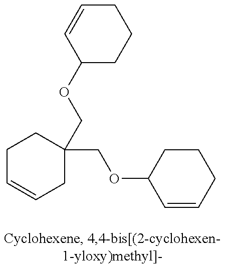 [SMILES: C1=CC(OCC2(COC3C=CCCC3)CC=CCC2)CCC1]

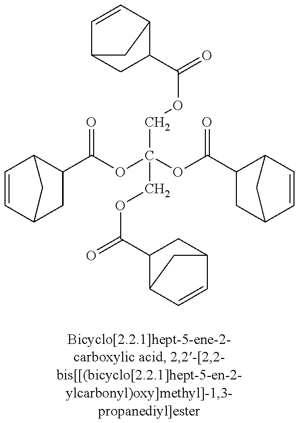 [SMILES: O=C(OCC(COC(=O)C1CC2C=CC1C2)(OC(=O)C1CC2C=CC1C2)OC(=O)C1CC2C=CC1C2)C1CC2C=CC1C2]

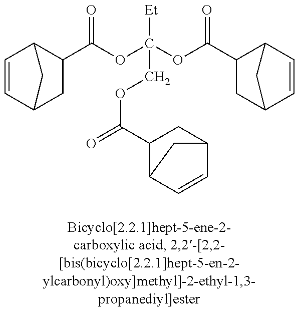 [SMILES: CCC(COC(=O)C1CC2C=CC1C2)(OC(=O)C1CC2C=CC1C2)OC(=O)C1CC2C=CC1C2]

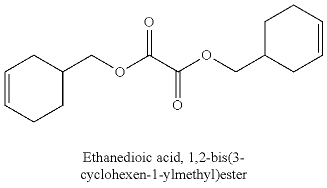 [SMILES: O=C(OCC1CC=CCC1)C(=O)OCC1CC=CCC1]

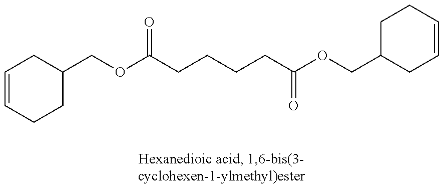 [SMILES: O=C(CCCCC(=O)OCC1CC=CCC1)OCC1CC=CCC1]

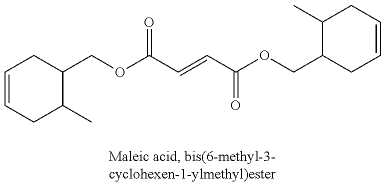 [SMILES: CC1CC=CCC1COC(=O)/C=C/C(=O)OCC1CC=CCC1C]

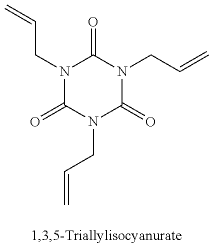 [SMILES: C=CCn1c(=O)n(CC=C)c(=O)n(CC=C)c1=O]

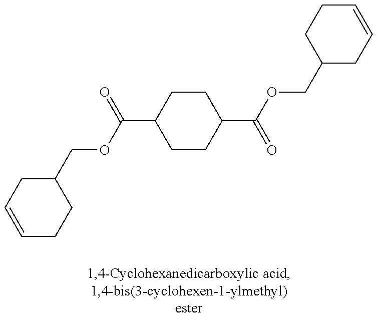 [SMILES: O=C(OCC1CC=CCC1)C1CCC(C(=O)OCC2CC=CCC2)CC1]

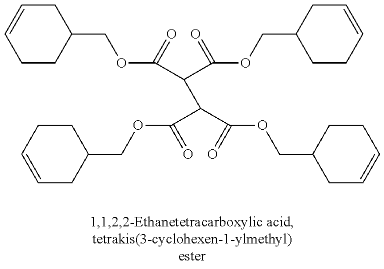 [SMILES: O=C(OCC1CC=CCC1)C(C(=O)OCC1CC=CCC1)C(C(=O)OCC1CC=CCC1)C(=O)OCC1CC=CCC1]

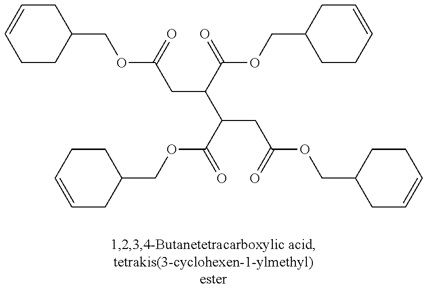 [SMILES: O=C(CC(C(=O)OCC1CC=CCC1)C(CC(=O)OCC1CC=CCC1)C(=O)OCC1CC=CCC1)OCC1CC=CCC1]

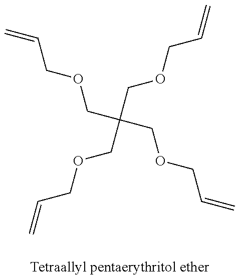 [SMILES: C=CCOCC(COCC=C)(COCC=C)COCC=C]

The quantity of an olefin in an olefinic solution of the subject invention is not limited and may be adjusted on the basis of the species of olefin in use. Typically, the weight of an olefin in an olefinic solution is 30 to 100% of the total solution.

Solvent

A solvent for an olefinic solution in the subject invention is varied on the basis of the species of olefin for epoxidation and the reaction conditions. A suitable solvent includes an aliphatic carboxylic acid ester, an alcohol or an alkyl-substituted derivative thereof, a cyclic or aromatic-substituted derivative thereof, a hydrocarbon or alkyl-substituted derivative thereof, a halogen-substituted derivative thereof, a ketone or an alkyl-substituted derivative thereof, a nitrile or an aryl substituted derivative, an ether, a heterocyclic compound, or the mixture of one or more of the above-mentioned substances. For example, a suitable solvent includes an aliphatic carboxylic acid ester, such as methyl acetate, ethyl acetate, propyl acetate, butyl acetate or the like; a straight or a branched chain type of methanol, ethanol, propanol, butanol, pentanol, hexanol, heptanol, octanol or the like or their alkyl-substituted derivatives; a cyclic or aromatic-substituted derivative, such as cyclohexanol, benzyl alcohol or the like; a straight or branched chain hydrocarbon, such as hexane or octane, or their alkyl-substituted derivative; an alicyclic hydrocarbon or an alkyl-substituted derivative thereof, such as cyclohexane, cycloheptane or the like; an aromatic hydrocarbon or an alkyl substituted aromatic hydrocarbon, such as benzene, naphthalene, toluene, xylene, or the like; a chlorinated hydrocarbon, such as chloroform, chlorobenzene, dichlorobenzene or the like; a ketone derivative, such as acetone, butanone, methyl isobutyl ketone or the like; a nitrile derivative, such as acetonitrile, propionitrile, butyronitrile, phenylacetonitrile or the like; an ether compound such as ether, butyl ether or the like; or a heterocyclic compound, such as dioxane, tetrahydrofuran or the like, wherein, in view of the peroxides which may be dissolved as an epoxidant, the solubility an olefinic reactant, and the selectability of an epoxy product, the preferred solvent is acetonitrile, acetone, butanol, 2-butanol, iso-octanol, cyclohexanol, benzyl alcohol, methyl acetate, ethyl acetate, butyl acetate, chloroform, dioxane, tetrahydrofuran or the like. Such solvents may be used alone or in combination.

Peroxide

A peroxide that may be used in the subject invention includes a hydroperoxy acid, a hydroperoxyl benzoic acid, an alkyl hydroperoxide, an alkyl substituted benzene hydroperoxide, an ester-substituted benzene hydroperoxide, a heterocyclic hydroperoxide, wherein a suitable peroxide comprises hydrogen peroxide, performic acid, peracetic acid, tert-butyl hydroperoxide, di(tert-butyl) peroxide, ten-amyl hydroperoxide, isopropylbenzene hydroperoxide, cumene hydroperoxide, benzoyl peroxide, cyclohexanone peroxide, dicumyl peroxide, methyl cyclohexyl hydroperoxide, tetralin peroxide, alkyl naphthalene hydroperoxide, and butyl peroxybenzoate. In addition, in view of industrial availability, the expoxidant used in the subject invention may be peracetic acid, tort-butyl hydroperoxide, or cumene hydroperoxide.

A peroxide used in the subject invention may be either commercially available or self-made. For a self-made peroxide, the preparation thereof is not specifically limited. For example, the peroxide may be obtained from the oxidation of its corresponding carboxylic acid, aldehyde, alcohol, ester and alkene according to the disclosure in Ullmann's Encyclopedia of Industrial Chemistry (Vol 26, Chapter: Peroxy Compounds, Organic, Wiley-VCH, 2012).

Continuous Reactor

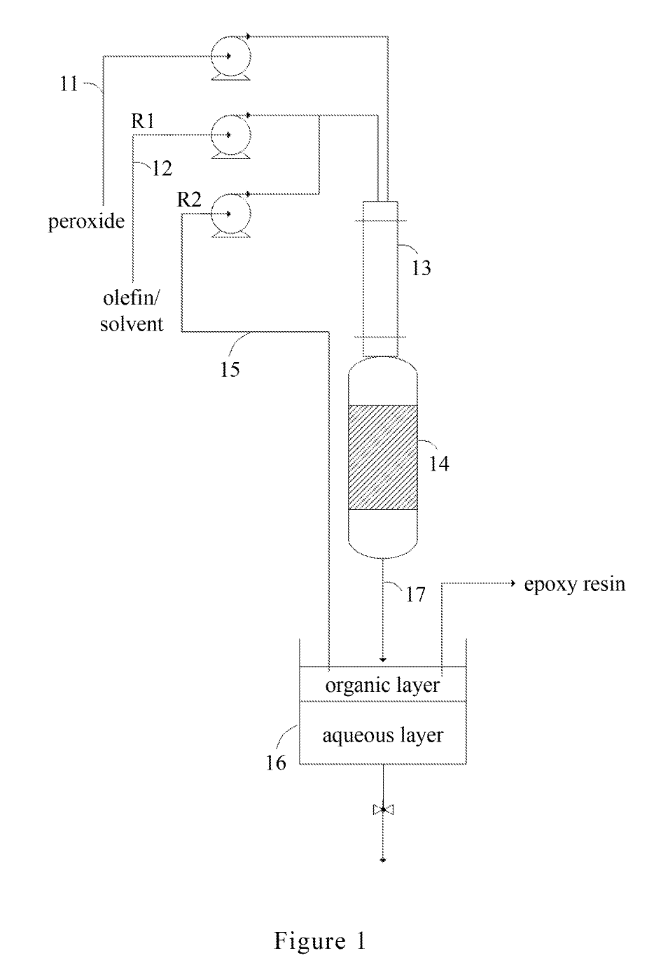

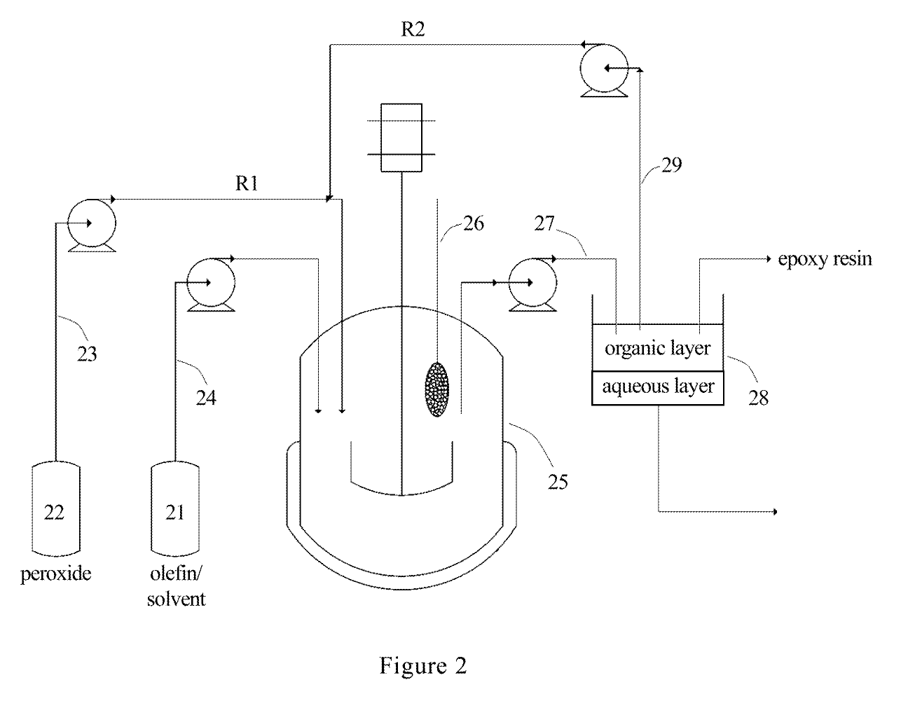

A continuous reactor that may be used in the subject invention is not limited to any type of the reactor. For example, a tubular reactor, a fixed bed reactor, a fluid-bed type reactor, and a continuously stirred tank reactors (CSTR). The said reactor may be a commercially available fluid-bed type reactor or a self-made reactor. In an embodiment of the subject invention, the reactor is selected from a fixed bed reactor and a continuously stirred tank reactor. FIG. 1 shows an embodiment of using a fixed bed reactor in the subject invention. FIG. 2 shows an embodiment of using a continuously stirred tank reactor in the subject invention.

In an embodiment of the subject invention, a continuous reactor further comprises an apparatus for homogeneous mixing of a reactant and an oxidant with the purposes of increasing the affinity of the water-oil phases and decreasing the effect resulting from the surface tension between the interfaces The apparatus may be selected from but is not limited to a pipe mixer, a vortex mixer, a static mixer or the like.

FIG. 1 is an embodiment of the subject invention, where a fixed bed reactor is used. A peroxide and an olefinic solution enter a static mixer 13 via pipelines 11 and 12, respectively. After being homogeneously mixed, the mixture enters the fixed bed reactor 14 to conduct a reaction, and the fixed bed reactor 14 is equipped with a catalyst. After reaction, the product enters a separation tank 16 via a pipeline 17 from the fixed bed reactor 14 and is separated into an organic layer and an aqueous layer. A portion of the organic layer reflows into the fixed bed reactor 14 via a pipeline 15 to conduct the reaction continuously, while a portion of the organic layer is processed to remove the solvent, and an epoxy resin is thus obtained.

FIG. 2 is another embodiment of the subject invention, where a continuously stirred tank reactor is used. A peroxide and an olefinic solution enter a continuously stirred tank reactor 25 to conduct a reaction via pipelines 23 and 24 from storage drums 21 and 22, respectively, and the continuously stirred tank reactor 25 is equipped with a catalyst 26. After reaction, the product enters a separation tank 28 via a pipeline 27 from the continuously stirred tank reactor 25 and is separated into an organic layer and an aqueous layer. A portion of the organic layer reflows into the continuously stirred tank reactor 25 via a pipeline 29 to conduct the reaction continuously, while a portion of the organic layer is processed to remove the solvent, and an epoxy resin is thus obtained.

The feeding ratio of olefinic solution and oxides may be adjusted based on the species of the olefinic solution and the oxide used. Normally, the feeding ratio for the equivalent of an unsaturated double bond of an olefinic solution to the equivalent of a peroxide is from 1:0.5 to 1:4, preferably from 1:1.05 to 1:1.2.

In an embodiment of the subject invention, an olefinic solution and a peroxide may be heated before being fed into a reactor. The heating temperature may vary based the species of olefin and peroxide used and the reaction conditions. For example, they may be heated up to 40 to 80° C., preferably 50° C. to 70° C., more preferably 55 to 65° C.

A process for separating the discharged organic layer and aqueous layer in the subject invention is not limited. A person having ordinary skill in the art may adapt a suitable process based on the efficacy as needed. In an embodiment of the subject invention, a separation tank is connected to the discharge end of a reactor.

A process of the subject invention comprises reflowing a portion of the separated organic layer into the reactor. The reflux ratio (R2/R1) of the reflux (R2) to the feeding of an olefinic solution (R1) may be adjusted based on the efficacy of the process as needed. Normally, the reflux ratio is from 0 to 10 and may be adjusted in view of on the conversion ratio of a process.

Collection of an Epoxy Resin

Collection of the epoxy resin includes a process of purifying an organic phase, which may be a conventional process that can improve the purity of the product, such as an extraction, dehydration, concentration or the like. The collection of the epoxy resin may further include removing the organic solvent from the organic layer, which may be conducted by a person having ordinary skill in the art through a conventional process, such as a vacuum concentration.

To increase the conversion rate and consequently the efficacy of the reaction and the purity of the product, a portion of the organic phase separated at the discharge end of a reactor may be retaken into the reactor to conduct the reaction prior to the step of collecting the epoxy resin or be transferred into another reaction kettle for being ripened.

Additive-Free

The process of the subject invention does not include any use of additive in a reaction step. Preferably, the process of the subject invention regarding collecting an epoxy resin does not include any use of additive, either.

Conventionally, an additive, such as a salt of an alkali metal or alkaline earth metal, must be injected in an olefinic epoxidation process to prompt a catalytic reaction, stabilize the reaction, or be used as a pH buffering agent, which may balance a small quantity of acid or base and maintain the overall pH value of the whole system. The process of the subject invention does not involve injecting any additive, thereby reducing costs, and avoiding a processing step regarding any side products.

### EXAMPLES

The following section discloses examples of the subject invention. However, the embodiments disclosed below are merely exemplary. The subject invention may be performed based on various alternative forms of the embodiments disclosed. Therefore, any specific component, condition, and detailed function disclosed in the embodiments in the specification cannot be construed as limitative. They should be understood as merely the basis of the claims and a representative basis for performing the subject invention in various fashions for a person having ordinary skill in the art.

a. Preparation of a Quaternary Ammonium Polystyrene Resin

A chloromethyl polystyrene resin (1.2 mmol Cl⁻/g) was measured at 20 g. 200 ml of 1,2-dichloroethane and 80 ml of ethanol were used as a swelling agent to swell chloromethyl polystyrene overnight. Triple chlorine equivalent of tertiary amine, e.g. 15.4 g of dodecyl dimethyl amine, was injected to conduct a refluxing reaction for 12 hours to prepare aminomethyl polystyrene. After suction filtration and scrubbing the reaction product with water and ethanol, yellowish quaternary ammonium methyl polystyrene, in which the chlorine ion attached on the methyl group was replaced by a tertiary amine, was thus produced.

b. Preparation of an Immobilized Phosphotungstic Acid Quaternary Ammonium Methyl Polystyrene Resin

23.04 g of phosphotungstic acid (H₃O₄₀PW₁₂·xH₂O) was dissolved and mixed in is 280 mL of water. 43.5 g of 50% hydrogen peroxide was slowly injected into the reacting solution. The reaction temperature was controlled around 60° C. After reaction for 1 hour, the temperature was cooled to room-temperature and then the as-swelled quaternary ammonium methyl polystyrene resin was slowly injected and vigorously stirred overnight. After suction filtration, the filtered cake was scrubbed by water and ethanol, and vacuum dried, and thus the immobilized phosphotungstic acid quaternary ammonium methyl polystyrene resin was obtained. (The phosphotungstic acid was grafted onto the quaternary ammonium methyl polystyrene resin.)

### Example 1

### Continuous Preparation of an Epoxy Resin

The immobilized phosphotungstic acid quaternary ammonium methyl polystyrene resin was filled in the fixed bed with top and bottom baffles thereon. The deficient height of the baffles was filled with glass beads or U-shaped wire net. 3-cyclohexene-1-carboxylic acid 3-cyclohexene-1-yl ester (CAS No. 2611-00-9) was dissolved in toluene, and it and hydrogen peroxide were placed into two storage drums separately. The temperature of the raw material solution was increased to 60° C. The olefin and oxidant were simultaneously fed on top of the fixed bed with a ratio of n(olefin)/n(oxidant)=1/2.2, and a static mixer was attached to the front end of the fixed bed to homogeneously mix the olefin and oxidant. After feeding, the reaction temperature was controlled. A separation tank was attached to the discharge end to separate the organic layer and the aqueous layer. A portion of the organic layer was reflowed with a reflow ratio of R2/R1=4 to the fixed bed for being reacted. A portion of the organic layer was vacuum concentrated to remove the organic solvent, and thus the target product 3,4-epoxycyclohexylmethyl-3,4-epoxycyclohexyl carboxylate (CAS No. 2386-87-0) was obtained with a conversion rate of 99.8%, a selectivity of the target product of 68.5%, and WHSV=0.49.

### Comparative Example 1

### Preparation of an Epoxy Resin Through a Batch Reaction

A heteropoly acid catalyst, which was the same as that in Example 1, was placed in a reaction kettle to conduct a batch reaction until achieving the same conversion rate as that of Example 1. The measured conversion rate, selectivity thereof and the resultants in Example 1 were concurrently listed in Table 1. The selectivity of Comparative Example 1 was 47%, which was lower than that of a continuous process in Example 1. The reason was the hydrogen peroxide and high temperature backmixing would increase hydrolysis of the product so that the selectivity was decreased.

TABLE 1

| | Example 1: | Comparative Example 1: |
|---|---|---|
| | continuous reaction | batch reaction |
| Conversation rate (%) | 99.4 | 99.8 |
| Selectivity of the | 68.5 | 47.0 |
| target product (%) | | |
| Dwelling time | WHSV = 0.49 | 8 Hrs |

### Comparative Example 2

### Experiment Involving Injecting an Additive During a Continuous and Batch Reaction

Table 2 lists the additives and the purposes of injecting an additive during an epoxidation process in the prior art references, CN 101492528, CN 101525320, and CN101891711.

TABLE 2

| | | Usage | Purpose |
|---|---|---|---|
| | | of the | of the |
| Prior art | Additives | additives | additives |
| CN 101492528 B | NaOH, Na₂CO₃, or | 1~5 wt % of | Catalytic |
| (Runze | KOH | the reactive | promoter |
| Pharmaceuticals | | solution | |
| Co., Ltd.) | | | |
| CN 101525320 B | Arbitrary mixture of Cl⁻, | 2 wt % of | Stabilizer |
| (Zhengzhou | Br⁻, or SO₄²⁻with Na⁺, | hydrogen | |
| University) | K⁺, Ca²⁺, or NH₄⁺ | peroxide | |
| | | usage | |
| CN 101891711 A | Phospholipid-containing | 1~3 wt % of | pH |
| (Shanghai | inorganic salt, including | hydrogen | buffering |
| Research | Na₃PO₄, Ca₃(PO₄)₂, | peroxide | agent |
| Institute of | Na₂HPO₄, K₂HPO₄, | usage | |
| Chemical | Na₄P₂O₇, K₄P₂O₇, or | | |
| Industry) | Na₅P₃O₁₀ | | |

Comparative Example 2 was an experiment conducted in a continuous and batch reaction on the basis of the additives selected from those used in the prior art references according to the following detailed steps:

The steps for a continuous reaction:
1. 10 g of an immobilized phosphotungstic acid quaternary ammonium methyl polystyrene resin was filled into a fixed bed.
2. 3-cyclohexene-1-carboxylic acid 3-cyclohexene-1-yl ester (CAS No. 2611-00-9) was dissolved in toluene, wherein the solid content was 33% (of the raw material solution). The additives were added to a 50% of hydrogen peroxide solution (the oxidizing solution).
3. The temperature of the raw material solution was raised to 60° C. The materials were simultaneously fed onto the fixed bed at a ratio of n(olefin)/n(oxidant)=1/2.2, and a static mixer was attached in front of the fixed bed to homogeneously mix the olefin and oxidant. After feeding, the reaction temperature was controlled. A separation tank was attached to the discharging end to separate the organic layer and the aqueous layer. A portion of the organic layer was reflowed into the fixed bed reactor with a reflow ratio of R2/R1=4. A portion of the organic layer was vacuum concentrated to remove the organic solvent, and the product, 3,4-epoxycyclohexylmethyl-3,4-epoxycyclohexyl carboxylate (CAS No. 2386-87-0), was obtained with a conversion rate of 99.8%, a selectivity of 68.5%, and WHSV=0.49.
The rest of the conditions and steps were the same. The difference merely lied in the additives injected into the oxidation solution. The results of the experiment were shown in Table 3.

The steps for a batch reaction:
10 g of an immobilized phosphotungstic acid quaternary ammonium methyl polystyrene resin, 150 g of 3-cyclohexene-1-carboxylic acid 3-cyclohexene-1-yl ester (CAS No. 2611-00-9), and 300 g of toluene were separately injected into a 1 L four-necked reaction flask, and the temperature was raised to 60° C.
2 A dropping pipe was used to inject 102 g of 50% hydrogen peroxide, and the reaction temperature was maintained at 65° C. for 7 hours. The product, 47% 3,4-epoxycyclohexylmethyl-3,4-epoxycyclohexyl carboxylate (CAS No. 2386-87-0), was thus obtained.
The rest of the conditions and steps were the same. The difference merely lied in the additives injected into the reacting solution. The results of the experiment were shown in Table 3.

TABLE 3

| Reaction | | | CAE1021 |
|---|---|---|---|
| type | Additives | Usage of additives | yield |
| Continuous | NaOH | 1 wt % of the reactive solution | 62% |
| reaction | NaCl | 2 wt % of hydrogen peroxide usage | 69% |
| | Na2HPO4 | 1 wt % of hydrogen peroxide usage | 72% |
| | none | none | 68.5 |
| Batch | NaOH | 1 wt % of the reactive solution | 54% |
| reaction | NaCl | 2 wt % of hydrogen peroxide usage | 62% |
| | Na₂HPO₄ | 1 wt % of hydrogen peroxide usage | 68% |
| | none | none | 47% |

In a batch reaction, the as-grown product would be continuously backmixed during the reaction and prompted the hydrolysis of the product. Therefore, the reaction yield was thus reduced. As for a continuous reaction, the temperature at the discharge end was reduced and the oil and water phases were separated. These effects improved the reduction of the hydrolysis of the product. Hence, the yield was higher than that of a batch reaction. However, the efficacy for injecting an inorganic salt into a continuous reactor was not obviously improved. In addition, the post-processing of the water phase was made more difficult, and the costs increased accordingly.

What is claimed is:

1. A process for continuously manufacturing an epoxy resin, comprising:
placing a heteropoly acid catalyst into a continuous reactor;
injecting an olefinic solution and a peroxide into the continuous reactor to conduct a reaction from a feeding end of the continuous reactor to form an organic layer and an aqueous layer; and
collecting the epoxy resin from the organic layer,
wherein the reaction steps do not include any use of an additive.

2. The process according to claim 1, wherein the continuous reactor is selected from a continuously stirred tank reactor and a fixed bed reactor.

3. The process according to claim 1, wherein the continuous reactor further comprises an apparatus for homogeneously mixing the olefinic solution and the peroxide.

4. The process according to claim 2, wherein the continuous reactor further comprises an apparatus for homogeneously mixing the olefinic solution and the peroxide.

5. The process according to claim 1, wherein the heteropoly acid catalyst is selected from phosphotungstic acid, silicotungstic acid, silicomolybdic acid, phosphomolybdic acid, or the combination thereof.

6. The process according to claim 1, wherein the weight of an olefin in the olefinic solution is in a range of 30% to 100% of the total solution.

7. The process according to claim 1, wherein an olefinic component in the olefinic solution comprises an alicyclic olefin and/or an aromatic olefinic compound.

8. The process according to claim 1, wherein a solvent for the olefinic solution is an aliphatic carboxylate; an alcohol or its alkyl-, cyclic-, or aryl-substituted derivative; a hydrocarbon or its alkyl- or halogen-substituted derivative; a ketone or its alkyl-substituted derivative; a nitrile or its aryl-substituted derivative; an ether; a heterocyclic compound or one or more of the mixture of the above-mentioned species.

9. The process according to claim 1 wherein the feeding ratio for an equivalent of an unsaturated double bond of the olefinic solution to the equivalent of the peroxide is 1:0.5 to 1:4.

10. The process according to claim 1, prior to collecting an epoxy resin, further comprising (1) a step of returning at least a portion of the organic layer into the continuous reactor to conduct the reaction, and/or (2) a step of transferring at least a portion of the organic layer into another reaction kettle for being ripened.

11. The process according to claim 1, wherein the step of collecting the epoxy resin comprises removing an organic solvent from the organic layer.
